(19) United States
(12) Patent Application Publication
(10) Pub. No.: US 2022/0281041 A1
(43) Pub. Date: Sep. 8, 2022

(54) ELECTRON-BEAM WELDING OF NICKEL-BASED SUPERALLOYS, AND DEVICE

(71) Applicant: Siemens Energy Global GmbH & Co. KG, Munich, Bayern (DE)

(72) Inventors: Bernd Burbaum, Falkensee (DE); Torsten Jokisch, Neuenhagen bei Berlin (DE); Britta Stöhr, Berlin (DE)

(73) Assignee: Siemens Energy Global GmbH & Co. KG, Munich, Bayern (DE)

(21) Appl. No.: 17/625,741

(22) PCT Filed: Jun. 15, 2020
(86) PCT No.: PCT/EP2020/066445

§ 371 Date: Jan. 8, 2022

(30) Foreign Application Priority Data
Jul. 15, 2019 (DE) 10 2019 210 423.1

(51) Int. Cl. B23K 35/30; B23K 15/00; B23K 26/32; B23K 26/28

(52) U.S. Cl. CPC B23K 35/3033; B23K 15/0093; B23K 26/32; B23K 26/28; B23K 2101/001

(57) ABSTRACT

A method for electron-beam welding of nickel-based superalloys includes joining two components of a component to be produced of nickel-based superalloys by electron radiation in which the electron radiation is guided with a feed rate of 12 mm/min to 120 mm/min, in particular of 40 mm/min to 80 mm/min, over a joining zone of the two components. A device for the electron-beam welding of two components to form a component of nickel-based alloys, which has at least a vacuum chamber, in which an electron radiation or laser radiation is generated and is directed onto a joining zone of two components to be joined.

### CROSS REFERENCE TO RELATED APPLICATIONS

This application is the US National Stage of International Application No. PCT/EP2020/066445 filed 15 Jun. 2020, and claims the benefit thereof. The International Application claims the benefit of German Application No. DE 10 2019 210 423.1 filed 15 Jul. 2019. All of the applications are incorporated by reference herein in their entirety.

### FIELD OF INVENTION

The invention relates to the welding, and a device by means of electron beams, of two nickel-based alloys.

### BACKGROUND OF INVENTION

The idea concerns the welded joining of components of nickel-based superalloys with a high y′ content, in particular moving turbine blades for the last turbine stage of the next generation of gas turbines, or generally long, thin-walled components. On account of the size, it is becoming increasingly difficult for hollow blades to be produced by casting. On account of the thin wall thicknesses at the tip of the blade and the size of the blade cores, casting defects may occur during production and lead to the turbine blade being rejected.

The welding of Ni-based or Co-based superalloys with a high tendency to hot crack has not previously been possible without the occurrence of at least minor hot cracks. Various phenomena, solidification cracks, remelting cracks, cracks caused by a decrease in toughness or so-called phased melting are the reason for extremely complex technologies for connecting such materials.

Previously, numerous methods have been used to obtain an extreme reduction in the introduction of heat, for example low-volume laser-powder welding, which leads to very high cooling-down gradients, but has the consequence of a low building-up rate. On the other hand, such materials are associated with low-value, tougher and/or less oxidation-resistant substances, in order to reduce stresses during the cooling-down phase. It has so far only been possible with great effort to achieve a bond close to the base material, i.e. identical in its properties.

A welding process has not previously been used for joining moving turbine blades of nickel-based superalloys with a high y′ content.

One possible alternative is to use casting to produce two blade components that are joined to one another.

### SUMMARY OF INVENTION

An object of the invention is therefore to solve this problem.

One possible alternative is to use casting to produce two blade components that are joined to one another.

The object is achieved by a method and a device as claimed.

The dependent claims list further advantageous measures which can be combined with one another as desired to achieve further advantages.

The idea is to use casting to produce two blade components that are joined to one another by means of electron-beam welding.

Investigations have shown that nickel-based superalloys can be joined without cracks at slow feed rates, in particular of 40 mm-80 mm/min, and with sheet thicknesses of up to 12 mm.

Such a process may be used for joining blade parts on hollow blades.

Beam welding of a large hollow blade of a nickel-based superalloy, in particular from row 3 and/or 4 of a turbine, with electron radiation in a process chamber is proposed.

The advantageous procedure is broken down into the following stages: —producing two turbine blade parts or a turbine blade and a blade tip by casting; —the two components are produced in particular with a shoulder all around at the joining zone; —clamping the two sub-components in a vacuum chamber, in order that a displacement of the two components during the welding process is avoided (alternatively: pre-fixing by means of high-temperature brazing); —joining the two components in the vacuum chamber by means of electron-beam welding; —electron-beam welding is carried out with a relatively low feed rate of 12 mm/min-120 mm/min, thereby avoiding crack initiation; —dissimilar joining zones are likewise realized, in particular of DS materials on SX materials, and so blade tip production/blade tip repair on turbine blades with improved oxidation resistance is possible.

Advantages include: joining a hot-gas component made up of simple castable sub-components; lowering the reject rates in the production of large turbine blades by casting; and saving costs and material.

The method described here is based on an increased introduction of heat, which however is not achieved by means of a preheating technique, such as induction, but is obtained from the liquid component of the welding.

In combination with the extremely slow feed rate of advantageously 30 mm/min to 60 mm/min, this leads to cooling-down conditions that prevent/extremely minimize hot crack formation. Purely computationally, this results in very high energy per unit length, which is normally specified as a reference for welding systems. However, because of the uneven geometrical distribution, this value is more of a nuisance here.

### BRIEF DESCRIPTION OF THE DRAWINGS

FIG. 1 and FIG. 2 schematically show the device and the procedure of the invention.

### DETAILED DESCRIPTION OF INVENTION

The figures and the description only represent exemplary embodiments of the invention.

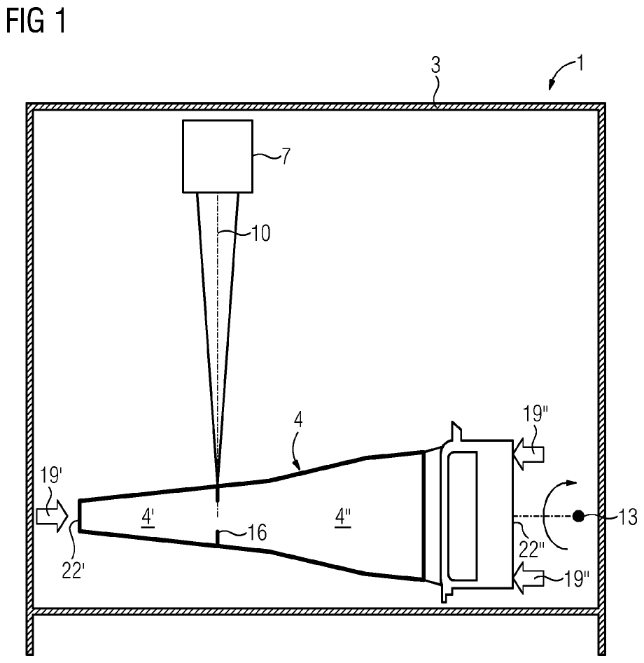

FIG. 1 schematically shows an installation 1 with a vacuum chamber 3, in which 3 a component 4 to be joined made up of the components 4′ and 4″ is arranged or can be arranged, and an electron-beam gun 7, which emits electron beams 10, or a laser.

The electron-beam gun 7 or the laser may also be arranged outside the vacuum chamber 3, the beams then being coupled into the vacuum chamber 3.

The joining zone, i.e. of contact areas of the components 4′, 4″, in the vacuum is advantageously freed of oxide layers in advance, in particular by vapor-deposition of 20 μm to 50 μm of a surface region.

Preferably, a joining zone is heated to 773 K to 1273 K before irradiating or joining.

The component 4 to be produced is advantageously pressed together at both opposite ends 22′, 22″ with a force 19′, 19″, and so the joining zone 16 is pressed together.

Preferably, a peripheral weld seam or join is produced, achieved by the component being turned about an axis 13 by means of a turning device.

The joining zone has a shoulder, which has a length of 8 mm to 12 mm.

The following parameters are advantageously used: welding with energy per unit length of higher than 600 J/mm or a feed rate of 0.2 . . . 0.5 . . . 1.0 . . . 2.0 mm/s.

Beam welding of a hollow component, in particular a hollow blade of a nickel-based superalloy, with electron beams in a process chamber with optional internal bath support is proposed, as shown in the present schematic representation.

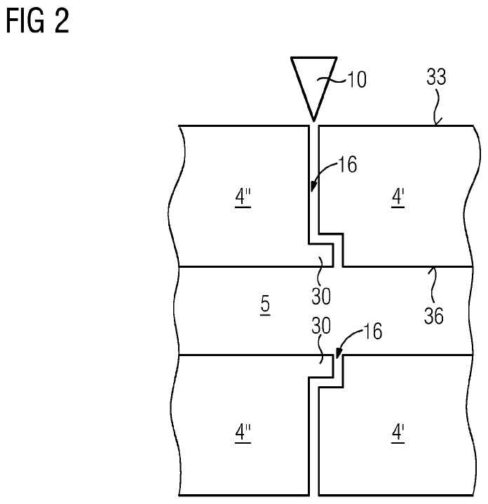

FIG. 2 shows the components 4′, 4″ to be joined and cavity 5, the component 4′ advantageously having a projection or shoulder 30 on an inner side 36.

The electron radiation 10 impinges on the opposite surface 33 of the inner area 36.

The shoulder 30 is present on the inner area 36 facing away from the electron radiation 10.

Thus, slipping transversely to the longitudinal direction or direction of the force 19′, 19″ is avoided.

The invention can also be applied to laser beams in a vacuum.

The components (4′, 4″) may comprise the same alloy or different alloys.

Different means that at least one alloying element (not an impurity) is present to a greater or lesser extent or that at least a proportion of the same alloying element differs by at least 20%.

A further advantageous procedure is in particular as follows: —clamping the two components 4′, 4″ in a holding and tilting device in a vacuum chamber; —preparing the joining zone in the vacuum by brief vapor deposition, in particular 20 μm-50 μm of the joining zone, and—preheating to T=773 K-1273 K of the joining area; —tilting and centering the two components 4′, 4″ with subsequent joining of the two components in the vacuum chamber by means of electron-beam welding.

Dissimilar joining zones may likewise be realized, for example alloy 247DS/PWA1483, in order that a repair of turbine blade tips with improved oxidation resistance is possible.

1. A method for joining two components of a component to be produced of nickel-based superalloys by means of electron radiation, the method comprising:
guiding the electron radiation with a feed rate of 12 mm/min to 120 mm/min, over a joining zone of the two components.

2. The method as claimed in claim 1,
wherein the components to be joined are pressed together during the joining by means of a force.

3. The method as claimed in claim 1,
wherein the components to be joined are turned by means of a turning device during the joining.

4. The method as claimed in claim 1,
wherein the joining via electron radiation has an energy per unit length of higher than 600 J/mm.

5. The method as claimed in claim 1,
wherein bath support is used in a cavity or hollow components.

6. The method as claimed in claim 1,
wherein one component has a shoulder, and the other component is formed as complementary thereto.

7. The method as claimed in claim 6,
wherein the shoulder is present on a surface facing away from the electron radiation.

8. The method as claimed in claim 1,
wherein the components comprise the same alloy.

9. The method as claimed in claim 1,
wherein the components comprise different alloys.

10. The method as claimed in claim 1,
wherein a laser in a vacuum is used instead of the electron radiation.

11. The method as claimed in claim 1,
wherein the joining zone of the components is in a vacuum and is freed of oxide layers.

12. The method as claimed in claim 1,
wherein the joining zone is heated to 773 K to 1273 K before irradiation or joining.

13. A device for electron-beam welding of two components to form a component of nickel-based alloys, comprising:
a vacuum chamber,
wherein an electron radiation or laser radiation is adapted to be generated and directed onto a joining zone of two components to be joined.

14. The device as claimed in claim 13, further comprising:
a turning device for turning the components.

15. The device as claimed in claim 13, further comprising:
means for pressing together the components by means of a force during the joining.

16. The method as claimed in claim 1,
wherein the feed rate is 40 mm/min to 80 mm/min.

17. The method as claimed in claim 1,
wherein the feed rate is 0.2 mm/s or 0.5 mm/s or 1.0 mm/s or 2.0 mm/s.

18. The method as claimed in claim 11,
wherein the joining zone is freed of oxide layers by vapor-deposition of material in the joining zone of 20 μm to 50 μm.
